(19) United States
(12) Patent Application Publication
(10) Pub. No.: US 2006/0252495 A1
(43) Pub. Date: Nov. 9, 2006

(54) Slot machine with skill aspect

(76) Inventors: Ignacio Gerson, Buenos Aires (AR); Alvaro Nores, Buenos Aires (AR); Diego Yanivello, Buenos Aires (AR)

Correspondence Address: MUSKIN & CUSICK LLC, 1800 CALLOWHILL ST, SUITE 200, PHILADELPHIA, PA, 19130, US

(21) Appl. No.: 11/337,960

(22) Filed: Jan. 23, 2006

Related U.S. Application Data
(63) Continuation-in-part of application No. 11/035,691, filed on Jan. 14, 2005.
(63) Continuation-in-part of application No. 11/326,125, filed on Jan. 3, 2006.
(60) Provisional application No. 60/766,403, filed on Jan. 17, 2006.
(60) Provisional application No. 60/597,956, filed on Dec. 27, 2005.

(51) Int. Cl. A63F 13/00

(52) U.S. Cl. 463/20; 463/30

(57) ABSTRACT

A game of skill slot machine in which different winning combinations can have different house commissions applied to same. Thus, if a player wishes to respin a reel, a respin cost can be computed utilizing applicable house commissions thus resulting in a skillful decision of which reel to respin.

### CROSS REFERENCE TO RELATED APPLICATIONS

This application claims benefit/priority to commonly owned provisional application 60/766,403, entitled, “Slot Machine with Skill Aspect,” which is incorporated by reference herein in its entirety. This application is a continuation in part of commonly owned application Ser. No. 11/326,125, entitled, “Slot Machine Bonus Game,” filed on Jan. 3, 2006, which claims benefit and priority to commonly owned provisional application No. 60/597,956, entitled, “Slot Machine Bonus Game,” filed on Dec. 27, 2005, both of which are incorporated by reference herein in their entireties. This application is also a continuation in part of commonly owned application Ser. No. 11/035,691, entitled, “Slot Machine Game That Allows Player to Purchase Reel Respins,” filed on Jan. 14, 2005, which is incorporated by reference herein in its entirety.

### BACKGROUND OF THE INVENTION

1. Field of the Invention

The present invention is directed to a method, apparatus, and computer readable storage to incorporate a skill element into a slot machine game.

2. Description of the Related Art

Slot machines are a billion dollar industry. The legality of slot machines depends on each respective jurisdiction. Certain jurisdictions may have particular requirements regarding game rules and/or payouts before a machine would be considered legal in that jurisdiction.

One such requirement is that some jurisdictions require a game to have a skill element. A traditional slot machine, wherein a player places a wager, pulls a handle, and views random symbol combinations, may not involve an aspect of skill. Thus, in some jurisdictions, such games may not be legal.

What is needed is a way in which a slot machine can incorporate a skill element, thus rendering the game legal in a jurisdiction which requires a skill element.

### SUMMARY OF THE INVENTION

It is an aspect of the present invention to provide a skill element in a slot machine.

The above aspects can be obtained by a method that includes (a) displaying a first reel and a second reel; (b) outputting a first respin cost for the first reel and a second respin cost for the second reel; and (c) receiving a selection from a player to respin either the first reel by paying the first respin cost or to respin the second reel by paying the second respin cost, wherein a first value of respinning the first reel based on the first respin cost is unequal to a second value of respinning the second reel based on the second respin cost.

The above aspects can also be obtained by a method that includes (a) receiving a selected reel from a player as to which reel to respin; (b) cycling through reel stops in the selected reel; (c) if a combination of reels, including the selected reel, forms a particular winning combination, then performing: (d) determining a variable house commission for the particular winning combination; (e) identifying a payout for the particular winning combination; (f) applying the variable house commission to the payout to determine an adjusted award; (g) accumulating adjusted awards; and (h) dividing the adjusted awards by a number of reel stops on the selected reel to determine a selected reel respin cost.

The above aspects can also be obtained by an apparatus that includes (a) an output unit outputting a first reel and a second reel and outputting a first respin cost for the first reel and a second respin cost for the second reel; and (b) an input unit receiving a selection from a player to respin either the first reel by paying the first respin cost or to respin the second reel by paying the second respin cost, wherein a first value of respinning the first reel based on the first respin cost is unequal to a second value of respinning the second reel based on the second respin cost.

### DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of determining a respin cost, according to an embodiment;

FIG. 2 is an exemplary data flow diagram illustrating data used in determining a variable respin cost (based on a variable house commission), according to an embodiment; and

FIG. 3 is an exemplary block diagram of hardware that can be used to implement an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a method, system, and computer readable storage which can incorporate a skill element into a slot machine game. This can be accomplished by permitting a player to choose a reel to respin, computing a cost to the player for the ability to respin a particular reel, and incorporating some skill in the player's selection of which reel to respin.

The 11/035,691 document describes a slot machine game which can allow the player to select a reel to respin, displays a cost associated with the respin, and allows the play to purchase the respin and awards and resulting prize after the respin. Using a uniform tax, each reel is typically taxed (e.g. a house commission is deducted) at an equal rate (e.g. all winning combinations are taxed equally), thus to respin each reel has a same value to the player (although the value may not be exactly the same due to rounding). Thus, if different alternatives have a same expected value, there is no skill involved in the choice.

An alternative method of determining a respin cost can be implemented, in which respinning different reels may have a different expected values or value. Thus, a player may be better off choosing a particular reel to respin over another. This gives the choice an element of skill. A value to a player can be defined as an expected value of a respin divided by its cost to the player. For example, to respin a first reel may cost the player $1 but has an expected value (an expected award) of $2. Thus the value of this respin to the player is $2/$1 or $2. To respin a second reel may cost the player $2 but has an expected award of $5. Thus the value of this respin to the player is $5/$2 or $2.50. Thus, the player would be skillful by choosing to respin the second reel even though its cost is higher. An expected value of a respin of a particular reel can be thought of as an average award of respinning that reel (independent of the cost of the respin).

This can be accomplished by taxing different winning combinations at different rates. For example, winning combinations involving a first symbol can be taxed at a first rate, while winning combinations involving a second symbol can be taxed at a second rate. In this manner, respin costs for each reel can have different expected values because different re-spun reels may have different winning possible combinations (with different respective tax rates).

An example can illustrate the principle. Table I illustrates an exemplary 6 stop reel strip (of course any other number of stops and symbols can be used as well).

TABLE I

A
B
B
C
C
C

Table II illustrates sample payouts for a two reel (each reel comprising a reel strip as illustrated in Table I) slot machine without using symbol weights (although of course in an embodiment symbols can be weighted as well).

TABLE II

| combination | payout | prob | contribution |
|---|---|---|---|
| AA | $27 | 1/36 | .75 |
| BB | $1 | 1/9 | .11 |
| other | $0 | .86 | 0 |
| Total | | 1 | .86 |

Thus, the hypothetical machine exemplified by Tables I and II has an expected return of 86%.

As an example, consider a player places an initial wager in this machine and the reels stop at a losing AB combination. The player now wishes to respin. According to a uniform tax, the respin cost of each reel is computed as follows. To respin the first reel (the “A” symbol), the ‘B’ symbol remains static. Thus, all of the symbols in the first reel are cycled through. There are only two possible winning combination (BB and BB since there are two ‘B’ symbols), each of which have a ⅙ chance of occurring and pays $1. Thus the respin cost is ($1+$1)/6)=$0.33. thus the respin cost (without a house commission) is $0.33. If the house were to add six percent, then 0.33*1.06=$0.35. Similarly, to respin the second reel (the “B” symbol), the ‘A’ symbol remains static and all possible symbols in the second reel are cycled through. The only possible winning combination is AA which pays $27, thus the respin cost is ($27/6)=$4.5. Adding the house's six percent in this example, the re-spin cost would be $4.5*1.06=$4.77. However, the player's expected value is directly related to the house commission. Thus, there is really no element of skill involved in the choice.

Now consider if a different tax rate was applied to different combinations. For example, Table III illustrates variable tax rates.

TABLE III

| winning combination | commission multiplier |
|---|---|
| AA | 1.05 |
| BB | 1.06 |

Thus, instead of applying the house commission (or tax) to the final sum of values, a variable house commission can be applied to each winning combination when calculating the cost for the respin. Applying this paradigm to the above example where the player has spun the reels into an AB combination.

The player now wishes to respin. The respin cost of each reel using a variable house commission is now computed as follows. To respin the first reel (the “A” symbol), the ‘B’ symbol remains static. Thus, all of the symbols in the first reel are cycled through. There are only two possible winning combination (BB and BB since there are two ‘B’ symbols), each of which have a ⅙ chance of occurring and pays $1. Thus the respin cost is ($1*1.06+$1*1.06)/6=0.35. Thus, note that the house commission is applied when computing each win (as opposed to applying it all at once in the prior algorithm). Thus, the cost for the respin is $0.33*1.06=0.35.

Similarly, to respin the second reel (the “B” symbol), the ‘A’ symbol remains static and all possible symbols in the second reel are cycled through. The only possible winning combination is AA which pays $27, thus the respin cost is ($27*1.05)/6=$4.725. Again, note that the house commission is applied to each individual payout. If there were different payouts on a respin involving different commission rates, then each commission rate would be applied to each payout and the sum total is then divided by the number of stops on the respun reel.

Note that in the above example, the expected value of respinning the first reel is 0.33, thus the player value on purchasing this respin for $0.35 is 0.33/0.35 or 0.94. In the second example, the expected value of respinning the second reel is $4.50 and thus to pay $4.725 to respin this reel results in a player value of 4.5/4.725 or 0.95. Thus, the player would be better off respinning the second reel because he gets a better return (value) than respinning the first reel.

Thus, by inspecting the reels, the player can typically determine which reel has the best player value to respin using skill. The more familiar with the game a player becomes, the more skillful he or she can be at reviewing respective costs for each reel to respin to determine which has the highest player value (return on investment).

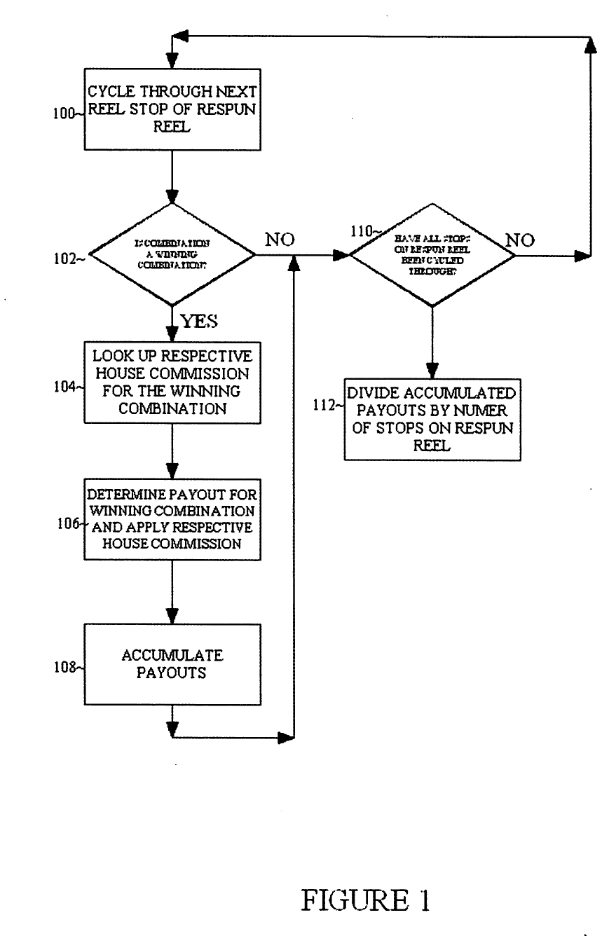

FIG. 1 is a flowchart illustrating an exemplary method of determining a respin cost, according to an embodiment. This method can be applied for each reel to display the respin cost for each of the reels at once, or can be applied when the player selects a particular reel so that the respin cost for that particular reel can be displayed.

The method can begin with operation 100, which cycles through a next reel stop of a respun reel (a respun reel is a reel in which the respin cost is being computed, even though the reel is not itself necessarily respun by the player).

From operation 100, the method can proceed to operation 102, which determines whether the combination of reels which comprise the cycled through reel stop from operation 100 contains a winning combination. This can be accomplished using a table of winning combinations.

If the determination in operation 102 determines that the combination is a winning combination, then the method can proceed to operation 104, which looks up a respective house commission for the winning combination. Different winning combinations can have different house commissions associated with them and they can be stored in a data structure such as a table.

From operation 104, the method can proceed to operation 106, which can determine a payout for a winning combination and apply the respective house commission determined in operation 104. The payout can be determined by looking up the winning combination in a table (e.g. 777 pays $100, etc.) and the house commission can then be applied (e.g. if the house commission is 10% then the payout can be multiplied by 1.10).

From operation 106, the method can proceed to operation 108, which accumulates the payouts determined in operation 106 (the payout which reflects the applied house commission).

From operation 108 (and operation 102 if operation 102 determines the combination is not a winning combination), the method can proceed to operation 110 which determines whether all reel stops in the respun reel have been cycled through. If they have not, then the method can proceed to operation 100, which cycles through a next reel stop of the respun reel. Typically all reel stops should be cycled through, including the reel stop which the original spin landed on.

If the determination in operation 110 determines that all reel stops have been cycled through (processed), then the method can proceed to operation 112, which divides the accumulated payouts (from operation 108) by the number of reel stops on the respun reel. This results in a respin cost which incorporates a variable house commission dependent upon particular winning combinations. This respin cost can optionally be rounded up (or down), if desired.

Thus, by applying the method illustrated in FIG. 1, each respin cost for each reel may have non-identical expected values. A skillful player may be able to discern which reel has a better (or best) value to respin (player value or return on investment).

It is noted that the method in FIG. 1 (or any of the other figures herein or in any document incorporated by reference) can be applied to a single line or multiple lines simultaneously. For example, if there is more than one active (lines which pay) paylines, the method can be applied separately for each active payline to determine a respin cost for multiple paylines. For example, the method illustrated in operations 102-108 can be applied for each payline but can be aggregated into a single aggregated payline total (i.e. by aggregating all determined payouts for all paylines in operation 108 or separately aggregating determined payouts for each payline in operation 108 and then adding all of the separately aggregated determined payouts together, either method of which results in an aggregated payline total), and when all stops on the respun reel have been cycled through then dividing the aggregated payline total (which comprises all paylines) by the number of stops on the respun reel to result in a respin cost for multiple paylines.

Table IV below illustrates another example of possible reel mappings.

TABLE IV

| Stop # | strip 1 | strip 2 | strip 3 |
|---|---|---|---|
| 1 | A | B | B |
| 2 | B | A | B |
| 3 | A | B | A |
| 4 | C | C | C |
| 5 | D | A | D |
| 6 | A | B | B |
| 7 | B | A | A |
| 8 | D | C | C |
| 9 | C | A | A |
| 10 | A | D | B |

Table V below illustrates exemplary paytables. Thus for example, a resultant combination 2 C symbols pays 4 and with 3 C symbols pays 10.

TABLE V

| A | pays |
|---|---|
| 2 | 1 |
| 3 | 3 |
| B | pays |
| 2 | 2 |
| 3 | 5 |
| C | pays |
| 2 | 4 |
| 3 | 10 |
| D | pays |
| 2 | 5 |
| 3 | 25 |

Table VI below illustrates a return rate for different prizes. A return rate can be thought of as similar to the house commission but is what the player is getting in return. For example a return rate of 80% means the player is getting an 80% return on his or her dollar. Thus, for example an award of $100 can be divided by the return rate of 80% ($100/0.80)=$125, thus the adjusted award (after house tax/commission) cost would be $125. This is similar to multiplying the award by 1.25 (adding a 25% house commission to the base award cost). These are two similar ways of looking at the same concept.

TABLE VI

| symbol | return |
|---|---|
| A | 80% |
| B | 85% |
| C | 90% |
| D | 95% |

Thus, for example, from Table VI, any winning combination involving an ‘A’ symbol (either 2 A's or 3 A's) from Table V can be applied a return rate of 80% (this would be applied in operation 106 of FIG. 1). Thus to apply the respective house commission the payout would be multiplied by $125 (100/0.8).

Table VII illustrates yet another example wherein different tax rates can apply to different combinations using a same symbol.

TABLE VII

| symbol | return |
|---|---|
| 2 A's | 80% |
| 2 B's | 85% |
| 2 C's | 90% |
| 2 D's | 95% |
| 3 A's | 82% |
| 3 B's | 88% |
| 3 C's | 94% |
| 3 D's | 91% |

Thus, a winning combination of 2 A's would return 80% while a winning combination of 3 A's would return 82%. A similar table can also be made for winning combinations of mixed symbols (e.g. a winning combination of ‘AB’ can be taxed at a different rate from a winning combination of ‘AA’).

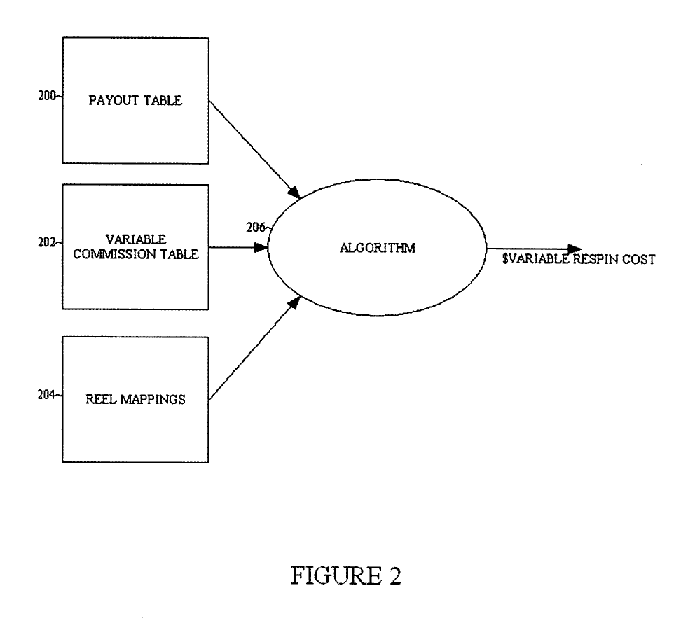

FIG. 2 is an exemplary data flow diagram illustrating data used in determining a variable respin cost (based on a variable house commission), according to an embodiment.

A payout table 200, a variable commission table 202 (as described herein), and reel mappings 204 can all be incorporated by an algorithm 206 in order to produce a variable respin cost. Not pictured may be any additional information needed by the algorithm.

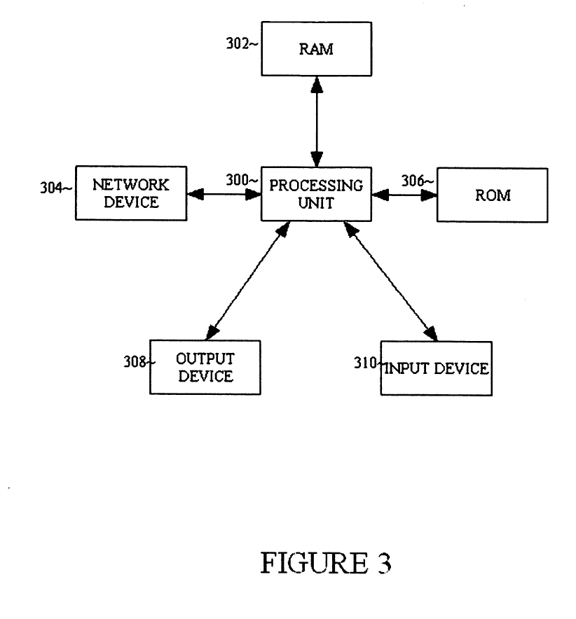

FIG. 3 is an exemplary block diagram of hardware that can be used to implement an embodiment.

A processing unit 300 can be connected to a ROM 306 (which can be a CD-ROM, DVD, etc.), a RAM 302, a network device 304 (to communicate with other devices on a network), an output device 308 (which can be an LCD, etc.), an input device 310 (which can be a touch screen, buttons, etc.), and any other device known in the art and needed for proper operation.

It is noted that any of the operations described herein can be performed in any sensible order. Further, any operations may be optional. Also, any feature or embodiment described herein can be combined with any other.

Further any type of slot machine can be utilized herein, whether a three reel, five reel, etc., video mechanical, etc. Any type of equipment can also be used with embodiments described herein, including any class (e.g. class II, class III, etc.)

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a wagering game, the method comprising:
displaying a first reel and a second reel;
outputting a first respin cost for the first reel and a second respin cost for the second reel; and
receiving a selection from a player to respin either the first reel by paying the first respin cost or to respin the second reel by paying the second respin cost,
wherein a first value to the player of respinning the first reel based on the first respin cost is unequal to a second value to the player of respinning the second reel based on the second respin cost.

2. A method as recited in claim 1, wherein the first value is computed by dividing the first respin cost over a first respin expected value which is an expected value of respinning the first reel, and the second value is computed by dividing the second respin cost over a second respin expected value which is an expected value of respinning the second reel.

3. A method as recited in claim 2, wherein the first respin cost is computed by:
cycling though all reel stops on the first reel
if each reel stop comprises a winning combination, then:
determining a respective house commission for the winning combination;
applying the respective house commission to a payout for the winning combination to determine an adjusted award;
accumulating the adjusted awards into an accumulated adjusted award; and
dividing the accumulated adjusted award by a number of reel stops on the first reel to determine a final respin cost.

4. A method as recited in claim 3, wherein the applying multiplies the respective house commission by the payout for the winning combination.

5. A method as recited in claim 3, wherein respective house commissions are different based on different winning combinations.

6. A method to determine a payout for a reel respin, the method comprising:
receiving a selected reel from a player as to which reel to respin;
cycling through reel stops in the selected reel;
if a combination of reels, including the selected reel, forms a particular winning combination, then performing:
determining a variable house commission for the particular winning combination;
identifying a payout for the particular winning combination;
applying the variable house commission to the payout to determine an adjusted award;
accumulating adjusted awards; and
dividing the adjusted awards by a number of reel stops on the selected reel to determine a selected reel respin cost.

7. A method as recited in claim 6, wherein a selected value of a respin on the selected reel is different than an alternate value of a respin on other reels.

8. A method as recited in claim 7, wherein value is defined as dividing a respective reel respin cost over an a respective expected value.

9. A method as recited in claim 6, wherein the determining uses a table of winning combinations and respective house commissions.

10. An apparatus to play a wagering game, the apparatus comprising:
an output unit outputting a first reel and a second reel and outputting a first respin cost for the first reel and a second respin cost for the second reel; and
an input unit receiving a selection from a player to respin either the first reel by paying the first respin cost or to respin the second reel by paying the second respin cost,
wherein a first value of respinning the first reel based on the first respin cost is unequal to a second value of respinning the second reel based on the second respin cost.

11. An apparatus as recited in claim 10, wherein the first value is computed by dividing the first respin cost over a first respin expected value which is an expected value of respinning the first reel, and the second value is computed by dividing the second respin cost over a second respin expected value which is an expected value of respinning the second reel.

12. An apparatus as recited in claim 11, wherein the first respin cost is computed by:
cycling though all reel stops on the first reel if each reel stop comprises a winning combination, then:
determining a respective house commission for the winning combination;
applying the respective house commission to a payout for the winning combination to determine an adjusted award;
accumulating the adjusted awards into an accumulated adjusted award; and
dividing the accumulated adjusted award by a number of reel stops on the first reel.
